(19) United States
(12) Patent Application Publication
(10) Pub. No.: US 2007/0204752 A1
(43) Pub. Date: Sep. 6, 2007

(54) Base construction for an air handling unit

(75) Inventors: Christopher A. Hord, Vancouver, WA (US); Chad O. Nelson, Beaumont, MS (US)

Correspondence Address: MCNEES WALLACE & NURICK LLC, 100 PINE ST., P.O. BOX 1166, HARRISBURG, PA, 17108-1166, US

(73) Assignee: YORK INTERNATIONAL CORPORATION, York, PA (US)

(21) Appl. No.: 11/369,037

(22) Filed: Mar. 6, 2006

(51) Int. Cl. B01D 49/00

(52) U.S. Cl. 96/390

(57) ABSTRACT

An apparatus and method for a panel construction for an air-handling unit includes at least one base member having a top surface and a bottom surface opposite the top surface and a skin having opposed surfaces. An insulator having opposed surfaces is disposed between the top surface of the at least one base member and the skin, one surface of the insulator being securely connected to the top surface of the at least one base member and the other surface of the insulator being securely connected to one surface of the skin. The secure connections between the opposed surfaces of the insulator and the top surface of the at least one base member and one surface of the skin substantially preventing a continuous path of substantially reduced thermal insulative properties between the at least one base member and the skin.

### FIELD OF THE INVENTION

The present invention is directed to a base construction for an air handling unit, and more particularly, to a base construction for an air handling unit having improved thermal properties.

### BACKGROUND OF THE INVENTION

Air Handling Units (AHUs) are one of several components in cooling and heating systems. They are an important component because the AHU houses a number of components used in the system to provide forced air for climate control in a particular structure. AHU components typically include motors, heating/cooling coils, and blowers as well as the required interface connections to effect such climate control.

The AHU is an enclosed interconnected framed panel structure. The framed panel structures include substantially thermally insulated panels that are supported between framing members, to define interconnected rectangular compartments. Although the panels are substantially thermally insulated, structural members are typically disposed between opposed skins to enhance the structural strength properties of the panel. Typically, the structural members and opposed skins, which are of metal construction, are secured together by metal screws. Therefore, despite the addition of insulating material between the skins, there is an amount of metal-to-metal contact between the opposed skins, which provides a continuous path of substantially reduced thermal insulative properties between the opposed skins. This reduction of thermal insulative properties adversely affects the efficiency of the cooling and heating system.

Similarly, the AHU is typically supported by robust base members, such as I-beams or C-channels. A layer of metal sheet often overlays the base members and serves as a floor for the AHU, with the floor being secured to the base members by metal fasteners. Despite the addition of insulating material layers and/or “air space” disposed beneath the floor and between the floor and the insulating material layers, there remains an amount of metal-to-metal contact between the base members and the floor which reduces the system efficiency of the cooling and heating system.

In addition, the atmospheric pressure inside the AHU can be significantly less than the atmospheric pressure outside of the AHU. Such difference in pressure subjects the floor to significant forces acting to draw the floor upwardly from the base members. Current measures to address this problem include using multiple mechanical fasteners to secure the floor to the base members and additionally significantly increasing the thickness of the floor. Not only do these measures increase the cost and weight of the AHU, but these measures fail to eliminate metal-to-metal contact between the base members.

Finally, the addition of through mechanical fasteners to secure the floor to the base members necessarily requires that apertures be formed in the floor to receive the fasteners. The floor is then susceptible to leakage of condensation that collects during operation of the AHU, despite attempts to seal the floor.

What is needed is an improved base construction that does not include a continuous path of substantially reduced thermal insulative properties between the floor and base members that is not susceptible to condensation leakage through the floor while permitting a decreased floor thickness.

### SUMMARY OF THE INVENTION

The present invention relates to a base construction for an air handling unit including at least one base member having a top surface and a bottom surface opposite the top surface and a skin having opposed surfaces. An insulator having opposed surfaces is disposed between the top surface of the at least one base member and the skin, one surface of the insulator being securely connected to the top surface of the at least one base member and the other surface of the insulator being securely connected to one surface of the skin. The secure connections between the opposed surfaces of the insulator and the top surface of the at least one base member and one surface of the skin substantially preventing a continuous path of substantially reduced thermal insulative properties between the at least one base member and the skin.

The present invention further relates to a base construction for an air handling unit including at least one base member having a top surface and a bottom surface opposite the top surface and a skin having opposed surfaces. An insulator having opposed surfaces is disposed between the top surface of the at least one base member and the skin. One surface of the insulator is securely connected to the top surface of the at least one base member and the other surface of the insulator is securely connected to one surface of the skin. The secure connections between the opposed surfaces of the insulator and the top surface of the at least one base member and one surface of the skin substantially preventing a continuous path of substantially reduced thermal insulative properties between the at least one base member and the skin. At least one bracket is connected to the skin, the at least one bracket being disposed adjacent to the at least one base member. The at least one bracket has a leg disposed substantially parallel to the skin and at least partially overlapping the top surface of the at least one base member. A layer of an insulating material is applied over the skin, wherein the layer substantially fills a space between the leg and the top surface of the at least one base member with insulating material.

The present invention still further relates to a method of constructing a base for an air handling unit. The method includes providing at least one base member to support an air handling unit, the at least one base member having a top surface and a bottom surface opposite the top surface and securely connecting one surface of an insulator having opposed surfaces to the top surface of the at least one base member. The method further includes securely connecting one surface of a skin having opposed surfaces to the surface of the insulator opposite the at least one base member and securely connecting one or more bracket to the skin. The one or more bracket is disposed adjacent to the at least one base member, the at least one bracket having a leg disposed substantially parallel to the skin and at least partially overlapping the top surface of the at least one base member. The method further includes applying a layer of an insulating material over the skin, wherein the layer substantially fills a space between the leg and the top surface of the at least one base member with insulating material.

An advantage of the present invention is that it provides improved thermal insulative properties for air handling unit floors.

A further advantage of the present invention is that the number of parts is reduced.

A yet further advantage of the present invention is that the air handling unit floor is not susceptible to condensation leakage through the floor.

A still further advantage of the present invention is that the air handling unit floor is strengthened without increasing the floor thickness.

Other features and advantages of the present invention will be apparent from the following more detailed description of the preferred embodiment, taken in conjunction with the accompanying drawings which illustrate, by way of example, the principles of the invention. Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### BRIEF DESCRIPTION OF THE DRAWINGS

FIG. 1 is a perspective cutaway view of a base of an AHU of the present invention.

FIG. 2 is a cross section of a base of an AHU taken along line 1-1 of the present invention.

FIG. 3 is an enlarged, partial cross section of a base of an AHU taken along line 1-1 of the present invention.

FIG. 4 is an enlarged, partial cross section of a base of an AHU taken along line 1-1 of the present invention.

FIG. 5 is an enlarged partial cross section of an alternate bracket construction of an AHU of the present invention.

FIG. 6 is an enlarged partial cross section of an alternate base construction of an AHU of the present invention.

FIG. 7 is an enlarged partial end view of a connection between a pair of base construction segments of an AHU of the present invention.

FIG. 8 is an enlarged partial exploded view of an alternate wall panel construction of an AHU of the present invention.

FIG. 9 is an enlarged partial end view of an alternate base construction shown supporting a wall panel of an AHU of the present invention.

Wherever possible, the same reference numbers will be used throughout the drawings to refer to the same or like parts.

### DETAILED DESCRIPTION OF THE INVENTION

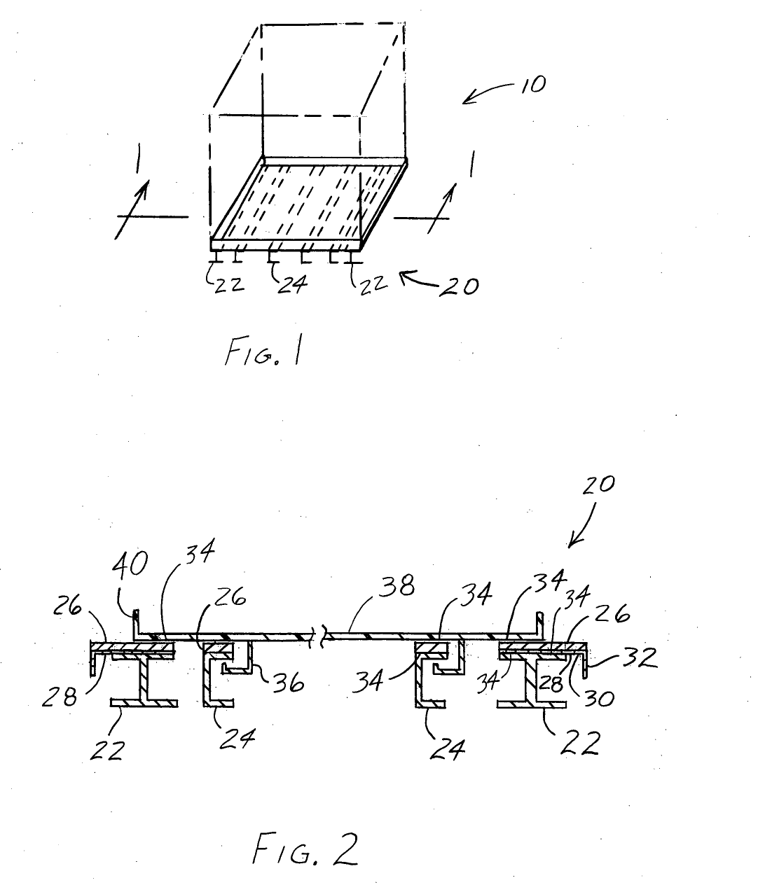

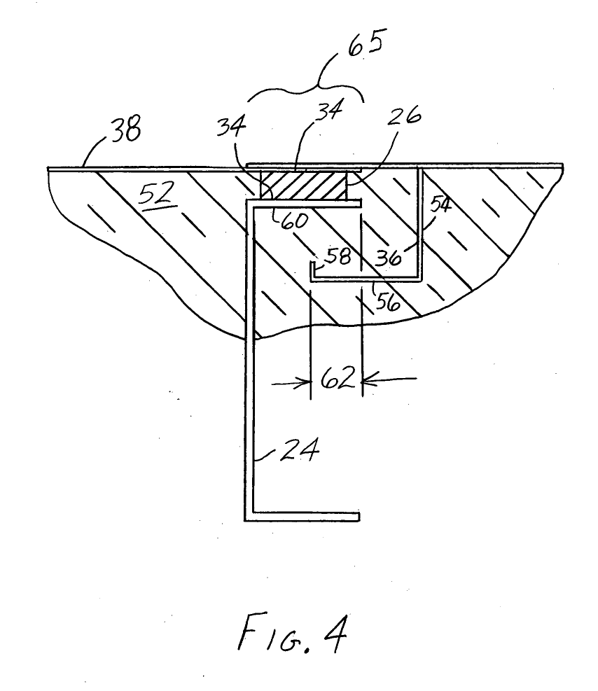

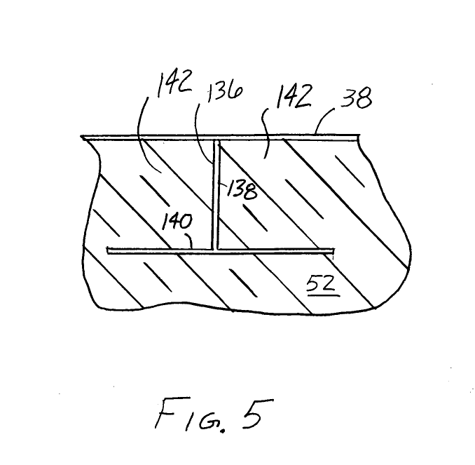

One embodiment of a base 20 for an AHU 10 of the present invention is depicted in FIG. 1. Preferably, referring to FIGS. 2-4, the base 20 includes a plurality of base members, such as I-beams 22 and C-channels 24, to support the AHU 10. The I-beams 22 and C-channels 24 are spaced apart, preferably parallel to each other, to provide structural stiffness and strength. In one embodiment, the I-beams 22 are arranged along the periphery of the base 20, with the C-channels 24 arranged at equal spacing between opposed I-beams 22. Once the I-beams 22 and C-channels 24 are arranged, a bracket 28 having substantially perpendicular legs 30, 32 is secured atop the peripherally arranged I-beams 22, followed by securing a layer of insulating material 26 atop each of the base members 22, 24. After securing the insulating material 26, a floor skin or skin 38, including a plurality of brackets 36 corresponding to the base members 22, 24, is secured atop the insulating material 26, followed by an application of a layer of insulating material 52 (FIG. 4) over the bracket 36. As will be discussed in further detail below, the AHU 10 lacks a continuous path of substantially reduced thermal insulative properties between the base members 22, 24 and skin 38.

After arranging the I-beam 22 and C-channel 24 base members, leg 30 of bracket 28 is secured to the upper surface of the I-beams 22, such as by a mechanical fastener 48, although adhesives, welding and other known methods may also be used. Preferably, leg 32 of bracket 28 extends downwardly for securing a panel 42, which is discussed below. Once the brackets 28 have been installed to the upper surfaces of the base members 22, 24, a layer of insulating material 26, such as polyiso foam board or polyisoboard, is secured atop each of the base members 22, 24. Polyisoboard is typically constructed of polyurethane material and has a density of between about 2 to about 6 pounds per cubic foot. It is preferred that the more dense polyisoboard is applied beneath portions of the floor that support heavy equipment due to the increased structural strength and stiffness of the more dense polyisoboard. However, it is desirable to user less dense polyisoboard where possible, as the thermal insulative value of the polyisoboard decreases as a function of increased density. Preferably, an adhesive layer 34 is applied to at least one corresponding surface between the base member 22, 24 and the insulating material 26 to secure the base member 22, 24 and the insulating material 26 together. Alternately, a layer of tape having an adhesive layer 34 applied to each opposed surface of the tape can be used to secure the base member 22, 24 to the insulating material 26.

Once the base member 22, 24 has been secured to the insulating material 26, skin 38 is then applied atop the insulating material 26, such as by adhesive layer 34, which can include a tape as previously discussed. In other words, mechanical fasteners are not required to secure the skin 38 to the insulating material 26, which eliminates the need to form apertures in the skin 38 to receive the mechanical fasteners. Alternately, a material, such as a bonding agent, which may be distinguished from an adhesive, can be applied between the insulating material 26, skin 38 and base member 22, 24 to provide a structural bond between the insulating material, skin and base member. As a result, although liquid can condense on the skin 38, there is no risk of leakage of the condensed liquid through the skin 38. Moreover, since the insulating material 26 prevents physical contact between the skin 38 and the base members 22, 24, there is no path of substantially reduced thermal insulative properties between the skin 38 and the base members 22, 24. Without the insulating material 26, a path of substantially reduced thermal insulative properties between the skin 38 and the base members 22, 24 otherwise occurs, as skin 38 and the base members 22, 24 are constructed of metal.

It is to be understood that metal fasteners that penetrate the skin 38, insulating material 26 and the base members 22, 24 provide a path of substantially reduced thermal insulative properties.

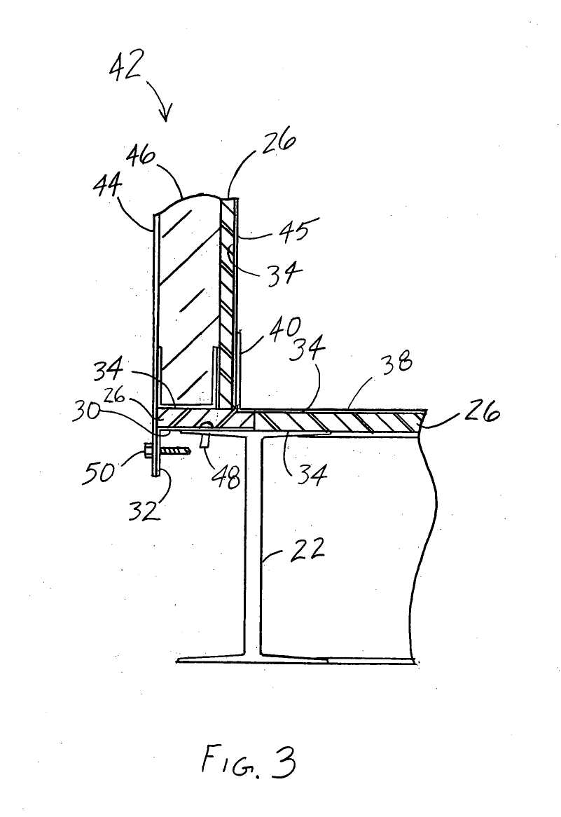

Similarly, as shown in FIG. 3, wall panels 42 assembled along the periphery of the base 20 do not provide a path of substantially reduced thermal insulative properties between the panels 42 and the base members 22, 24. The construction of the panels 42, which is described in an application titled “PANEL CONSTRUCTION FOR ΔN AIR HANDLING UNIT” is hereby incorporated by reference in its entirety. To secure panel 42 to base 20, an edge of panel 42 is directed into contact with insulating material 26 abutting an upper surface of I-beam 22. Preferably, an adhesive layer 34 is applied to at least one corresponding surface between the panel 42 and the insulating material 26 to secure the panel 42 and the insulating material 26 together. Alternately, a layer of tape having an adhesive layer 34 applied to each opposed surface of the tape can be used to secure the panel 42 to the insulating material 26. Additionally, skin 44 of the panel 42 includes a flange that extends past the body of the panel 42 and abuts leg 32 of bracket 28. Leg 32 and the flanged skin 44 are secured, such as by a mechanical fastener 50. An opposite skin 45 of panel 42 which is separated from skin 44 by insulating material 46 and a vertically disposed insulating material 26, is secured to the insulating material 26 by an adhesive layer 34 as previously discussed. Preferably, the surface of skin 45 facing away from insulating material 26 is secured to flange 40 of the skin 38. Therefore, as further shown by FIG. 3, peripheral flange 40 and skin 45 are thermally isolated from skin 44 by insulating material 46.

Referring to FIG. 4, skin 38 is further thermally insulated by a layer of insulating material 52. Preferably, prior to application of insulating material 52, such as sprayed on or injected polyurethane foam, base 20 is inverted. Preferably, a sufficient quantity of insulating material 52 is applied to at least cover brackets 36. In one embodiment, bracket 36 includes a leg 54 that extends substantially perpendicular from skin 38 which further extends to a leg 56 that extends substantially parallel to the skin 38. Optionally, leg 56 further extends to a flange 58 that extends toward the skin 38. Leg 54 is secured to the skin 38 by welding or other known bonding technique that does not form an opening through the skin 38. Thus, even when multiple skins are assembled to form the skin 38, such as by an overlap 65 of adjacent portions of the skin 38, since the skin 38 is bonded along the seam of the overlap 65, no condensed liquid forming on the upper surface of the skin 38 can leak through the skin 38.

Brackets 36 are preferably disposed so that there is an overlap 62 between leg 56 and a portion of a horizontal leg 60 of a base member, such as C-channel 24. Since bracket 36 is formed into short lengths, such as about 2-4 inches, it is possible to inject insulating material 52 to substantially fill the entire region between the skin 38 and leg 56 of bracket 36, including overlap 62. As a result, due to the stiffness of the insulating material 62, the overlap 62 between leg 56 of bracket 36 and the horizontal leg 60 of the base member 22, 24 provides structural stability to the skin 38, especially when the skin 38 is subjected to a negative pressure environment during operation of the AHU.

A negative pressure environment is encountered when the level of atmospheric pressure acting on the upper surface of the skin 38 is less than the level of atmospheric pressure acting on the lower surface of the skin 38. In other words, in a negative pressure environment, the skin 38 is urged away from the base member 22, 24. To counteract this effect, insulating material 52 disposed in the overlap 62 between leg 56 and leg 60 is compressed during this negative atmosphere pressure to resist movement of the skin 38 away from the base member 22, 24 caused by exposure of the skin 38 to the negative pressure. The length and number of brackets 36 required depends upon the stiffness of the foam material as well as the anticipated level of negative pressure and the amount of surface area of the skin 38. Thus, the bracket length can significantly deviate from the preferred 2-4 inch length range. Additionally, the length of the legs 54, 56, 58 are not necessarily the same dimension. By making use of the overlap 62, through fasteners are avoided which provides a skin 38 having no through metal connections extending from the base members 22, 24 to the skin 38, enhancing the thermal insulative properties of the base 20.

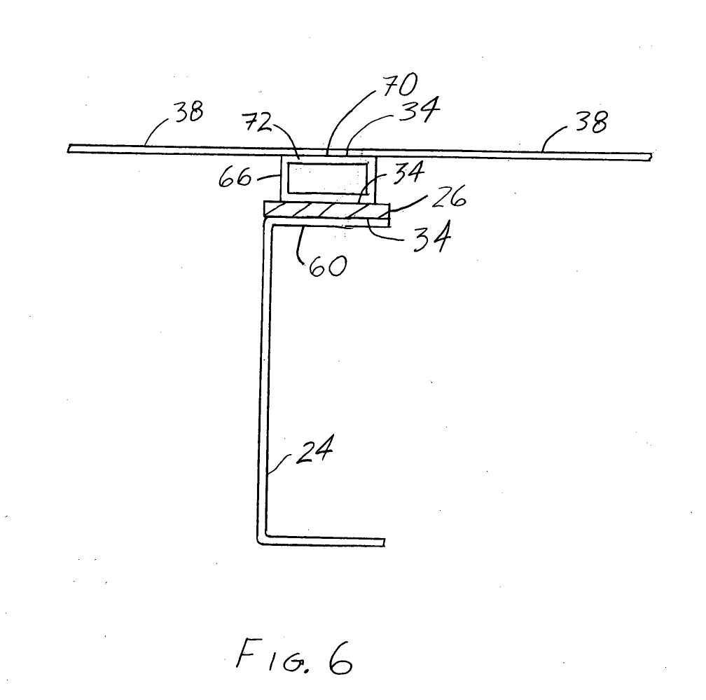

In an alternate construction as shown in FIG. 5, and which can be used in combination with bracket 36, bracket 136 may need to be arranged adjacent to a horizontally disposed leg of a base member 22, 24. In other words, bracket 136 may not require an overlap 62 with base members 22, 24. As shown, bracket 136 includes a leg 138 extending substantially perpendicular to the floor skin 38 that further extends to a leg 140 that is disposed substantially parallel to the skin 38. The legs 138, 140 of bracket 136 define a pair of channels 142 into which an amount of insulating material 52 is disposed. The efficacy of bracket 136 depends upon the structural properties of the insulating material 52 to resist movement of bracket 136 away from the base members 22, 24, which is akin to retrieving an anchor suspended in a sheet of ice.

It is to be understood that brackets 36, 136 can include any construction that includes a leg or legs extending away from the skin 38 that overlaps a portion of a base member 22, 24. In the alternative, brackets 36, 136 can include any construction having a leg or legs extending away from the skin 38 that defines at least one channel 142 between the bracket 36, 136 and the skin 38.

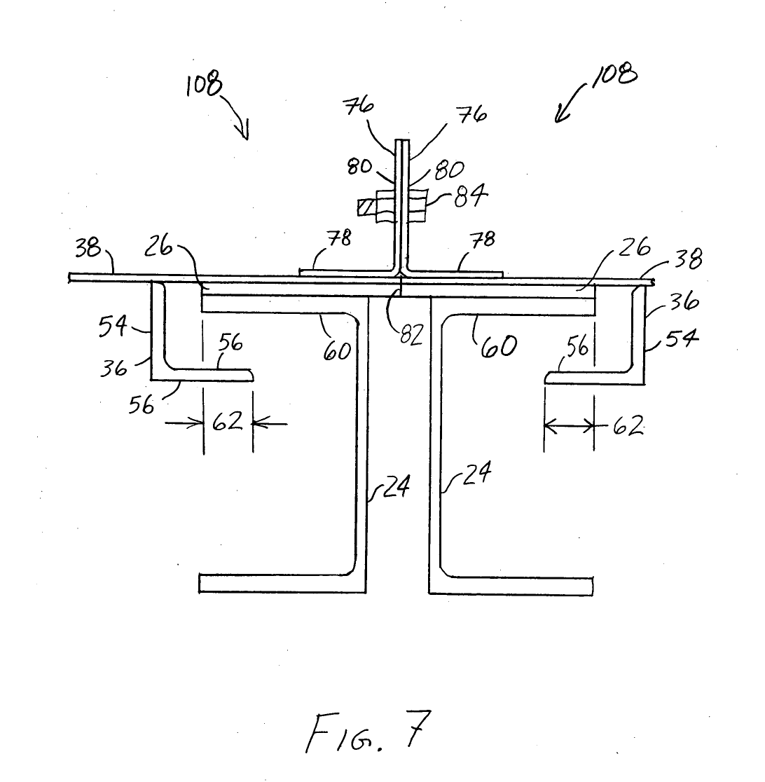

An alternate construction of the base is shown in FIG. 6 wherein the horizontal leg 60 of the base member 24 supports insulating material 26 and a structural member, such as a tube 66, that overlies the insulating material 26. Tube 66 is in contact with and supports the floor skin 38. Adhesive layers 34, which can include a bonding material or a tape as previously discussed, is used to secure skin 38, tube 66 and base member 24 at least temporarily until insulating material (not shown in FIG. 6; see FIG. 4) is applied. By avoiding the metal-to-metal contact between fastener 64 and tube 66, there can also be no metal-to-metal contact extending from the floor skin 38 to the base member 24. Preferably, tube 66 is disposed beneath a seam 70 formed between adjacent edges of sheets of floor skin 38, the seam preferably being welded together to provide a fluid tight seal. By positioning tube 66 in contact with the floor skin 38, not only does the tube 66 protect the insulating material 26 from damage resulting from the welding operation to the seam 70, but the same welded seam 70 additionally welds the tube 66 to the seam 70, providing an efficient technique to simultaneously bond the floor skin 38 edges and the tube 66 in a single bonding process.

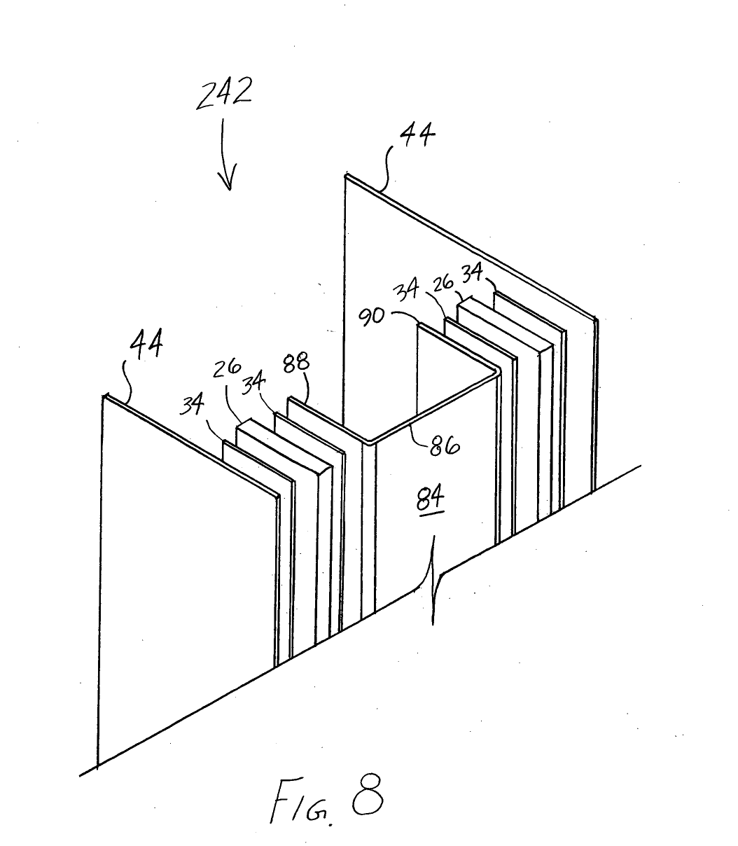

FIG. 7 shows a base construction in which two separate base subassemblies 108 can be assembled together along a common juncture 82. This separable joint is typically referred to as a split, since the AHU may be required to be assembled into smaller portions for shipping purposes. Each subassembly 108 includes structural support of the floor skin 38 by horizontal legs 60 of base members 24. Horizontal legs 56 of brackets 36 form overlaps 62 with respective portions of horizontal legs 60 to secure floor skin 38 as previously discussed. A pair of angles 76 are disposed adjacent the juncture of the base assemblies 108 with vertical legs 80 preferably being disposed coincident with the juncture 82 so that when the base subassemblies are brought together, surfaces of the vertical legs 80 are in mutual conformal contact. Preferably, removable fasteners 84 used to secure the adjacent vertical legs 80 together are disposed adjacent to the upper ends of the vertical legs 80 to permit condensation to collect on the floor skin 38 to a desired depth that is below the position of the apertures formed in the vertical legs 80 necessary for mounting the fasteners 84. The horizontal legs 78 are preferably secured to the floor skin 38 by welding, so that the angle 76 forms a fluid tight seal with the floor skin 38. In other words, as shown in FIG. 7, each subassembly 108 defines a fluid tight seal between the floor skin 38 and the respective angle 76 extending along the perimeter of each subassembly capable of collecting an accumulation of condensation above the floor skin 38 to a depth corresponding to the location of the fastener apertures formed in vertical legs 80 of the angles 36. Alternately, it is possible to secure the vertical walls 80 together with a clamp, so that no apertures are formed in the vertical walls.

It is to be understood that the construction as shown in FIGS. 6-9 also include application of insulating material 52 (see FIGS. 4 and 5) that is not shown for clarity of showing features of the base construction of the present invention. That is, for example, in FIG. 9, insulating material applied to the underside of the floor skin 38 flows into gap 104 and under angles 54 that similarly overlap corresponding horizontal legs of structural members, e.g., base member 24, so that the floor skin 38 remains in position when the floor skin is subjected to a negative pressure.

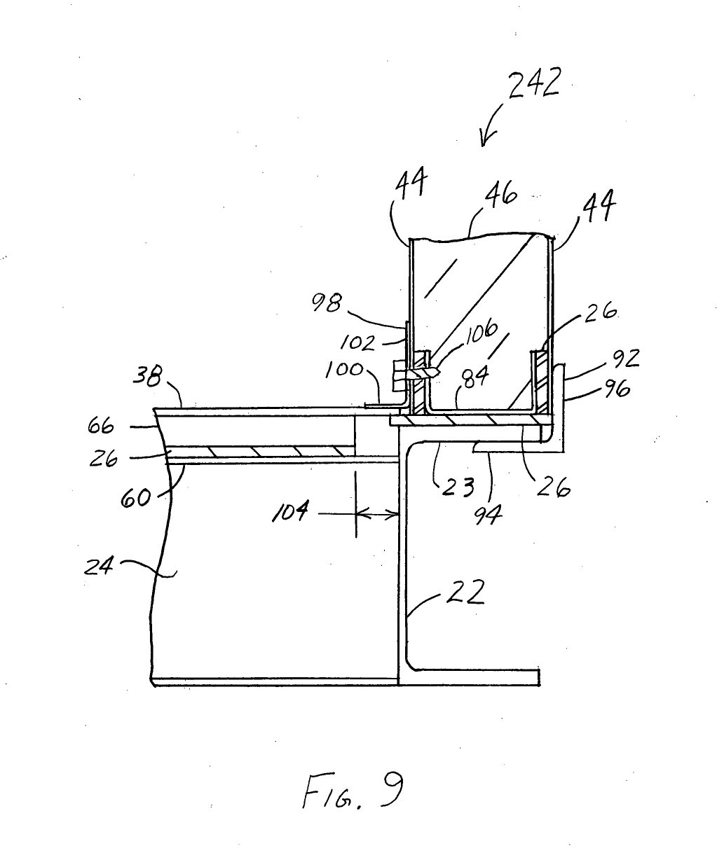

An alternate wall panel 242 construction as shown in FIG. 8 includes a structural member 84, such as a C-channel, having a web 86 disposed between opposite legs 88, 90. An adhesive layer 34, which can be in the form of tape having adhesive applied to each of the opposed surfaces of the tape, is disposed between each of legs 88, 90 and insulating material 26. The surface of insulating material facing away from structural member 84 is bonded to a surface of respective skins 44 by additional adhesive layers 34. In other words, panel 242 can be assembled without mechanical fasteners, which are typically constructed of a material, i.e., metal, having a low thermal insulation value, that would otherwise lower the insulating efficiency of the wall panel 242 by providing a continuous path of substantially reduced thermal insulative properties between opposed skins 44. The region defined by the opposed skins 44 and structural members 84 (one structural member 84 not shown for clarity in FIG. 8), is filled with insulating material 46 as previously discussed.

An alternate base construction is shown in FIG. 9 includes use of a base member 22 in the form of a C-channel instead of an I-beam along the perimeter of the base, wall panel 242 and the alternate base construction shown in FIG. 6. FIG. 9 shows one side of the base construction, wherein base member 22 forms one side of the base support, and one of the plurality of transversely disposed base members 24 that are secured to the base member 22, preferably by welding. To prevent damage to the insulating material 26 supported by horizontal leg 60 of base member 24 that would otherwise be damaged by welding the horizontal leg 60 to the base member 22 (and additional welding described below), the tube 66 and insulating material 26 are trimmed short of flush with the edge of base member 24 as indicated by gap 104. Floor skin 38 does not need to be trimmed. The wall panel 242 rests upon insulating material 26 that is secured to the upper surface of horizontal leg 23 of base member 22. An angle 98 has a horizontal leg 100 that is secured to the floor skin 38, preferably by welding, to preferably achieve a fluid tight seal therebetween. Preferably, the length of horizontal leg 100 is less than the gap 104 to prevent damage to the insulating material 26 during the welding process for securing horizontal leg 100 to the floor skin 38.

A vertical leg 102 of the angle 98 is positioned to contact the facing surface of skin 44 of the wall panel 242. Contacting corresponding surface of the opposite skin 44 of wall panel 242 is a vertical leg 96 of angle 92. A horizontal leg 94 of angle 92 is secured to the lower surface of leg 23 of base member 22 to better secure wall panel 242. To secure wall panel 242 in position, a removable fastener 106 can be directed through the vertical leg 102 of angle 98 and into wall panel 242. Preferably, the location of fastener 106 is above a predetermined maximum desired level of condensation that can be collected by the floor skins and angles 98. In other words, the aperture formed in the vertical leg 102 is above the fluid level reached when a predetermined maximum desired level of condensation is collected in the base construction of the present invention. It is to be understood that although structural support members are shown as C-channel or I-beam, these members could also be of any other geometry capable of supporting the floor skin and wall panels.

It is also to be understood that the structural support members could also be of any other geometry capable of supporting the floor skin and wall panels so long as the construction is configured to prevent a continuous path of substantially reduced thermal insulative properties between the structural support members and the floor skin. Additionally, although the insulating material is shown as being contiguous, i.e., single, continuous, unitary construction, the insulating material can also be provided in a discontinuous fashion, such as a plurality of segments of insulating material.

It is to be understood that the base construction of the present invention could include only the arrangement as shown in FIG. 9, i.e., not include structural members 22, only structural members 24. Alternately, the base construction could only include structural members 22 if desired.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A base construction for an air handling unit comprising:
at least one base member having a top surface and a bottom surface opposite the top surface;
a skin having opposed surfaces;
an insulator having opposed surfaces being disposed between the top surface of the at least one base member and the skin, one surface of the insulator being securely connected to the top surface of the at least one base member and the other surface of the insulator being securely connected to one surface of the skin; and
wherein the secure connections between the opposed surfaces of the insulator and the top surface of the at least one base member and one surface of the skin substantially preventing a continuous path of substantially reduced thermal insulative properties between the at least one base member and the skin.

2. The base of claim 1 wherein the skin is composed of a metal.

3. The base of claim 2 wherein the skin has no apertures formed therein.

4. The base of claim 3 wherein the skin is fluid tight.

5. The base of claim 1 wherein at least one of the secure connections is achieved with an adhesive.

6. The base of claim 1 wherein at least one of the secure connections is achieved with a bonding agent.

7. The base of claim 1 further comprising at least one bracket, the at least one bracket being disposed adjacent to the at least one base member, the at least one bracket having a leg disposed substantially parallel to the skin and at least partially overlapping the top surface of the at least one base member; and
a layer of an insulating material applied over the skin, wherein the layer substantially fills a space between the leg and the top surface of the at least one base member with insulating material.

8. The base of claim 1 wherein the insulator is polyisoboard.

9. The base of claim 8 wherein the polyisoboard is discontinuous.

10. The base of claim 1 further comprising a support member disposed between the insulator and the skin.

11. The base of claim 10 wherein the support member is aligned to support facing edges of adjacent portions of the skin.

12. The base of claim 10 wherein when the facing edges are secured together, the facing edges are also secured to the support member.

13. The base of claim 1 comprising one or more bracket connected to the skin and extending away from the skin, the one or more bracket and the skin defining a channel, the one or more bracket at least partially overlapping the top surface of the at least one base member; and
a layer of an insulating material applied over the skin and the one or more bracket, wherein the layer substantially fills the channel with insulating material.

14. A base construction for an air handling unit comprising:
at least one base member having a top surface and a bottom surface opposite the top surface;
a skin having opposed surfaces;
an insulator having opposed surfaces being disposed between the top surface of the at least one base member and the skin, one surface of the insulator being securely connected to the top surface of the at least one base member and the other surface of the insulator being securely connected to one surface of the skin;
wherein the secure connections between the opposed surfaces of the insulator and the top surface of the at least one base member and one surface of the skin substantially preventing a continuous path of substantially reduced thermal insulative properties between the at least one base member and the skin;
at least one bracket connected to the skin, the at least one bracket being disposed adjacent to the at least one base member, the at least one bracket having a leg disposed substantially parallel to the skin and at least partially overlapping the top surface of the at least one base member; and
a layer of an insulating material applied over the skin, wherein the layer substantially fills a space between the leg and the top surface of the at least one base member with insulating material.

15. The base of claim 14 further comprising a support member disposed between the insulator and the skin.

16. The base of claim 15 wherein the support member is aligned to support facing edges of adjacent portions of the skin.

17. The base of claim 16 wherein when the facing edges are secured together, the facing edges are also secured to the support member.

18. A method of constructing a base for an air handling unit, the steps comprising:
providing at least one base member to support an air handling unit, the at least one base member having a top surface and a bottom surface opposite the top surface;
securely connecting one surface of an insulator having opposed surfaces to the top surface of the at least one base member;
securely connecting one surface of a skin having opposed surfaces to the surface of the insulator opposite the at least one base member;
securely connecting one or more bracket to the skin, the one or more bracket being disposed adjacent to the at least one base member, the at least one bracket having a leg disposed substantially parallel to the skin and at least partially overlapping the top surface of the at least one base member; and
applying a layer of an insulating material over the skin, wherein the layer substantially fills a space between the leg and the top surface of the at least one base member with insulating material.

19. The method of claim 18 wherein the secure connections between the opposed surfaces of the insulator and the top surface of the at least one base member and one surface of the skin substantially preventing a continuous path of substantially reduced thermal insulative properties between the at least one base member and the skin.

20. The method of claim 18 wherein the step of securely connecting one surface of a skin includes the step of inserting a support member having opposed surfaces between the surface of the insulator opposite the at least one base member and the skin so that the one surface of the skin is then securely connected to one surface of the support member and that the other surface of the support member is securely connected to the surface of the insulator opposite the at least one base member.
